(19) United States
(12) Patent Application Publication
(10) Pub. No.: US 2025/0104359 A1
(43) Pub. Date: Mar. 27, 2025

(54) SYSTEMS AND METHODS FOR MANAGING AVATAR BASED COMMUNICATIONS

(71) Applicant: Meta Platforms Technologies, LLC, Menlo Park, CA (US)

(72) Inventors: Curt Wong, Bellevue, WA (US); Yousef Abdelmalek, New Providence, NJ (US); Xiaodi Zhang, San Ramon, CA (US)

(73) Assignee: Meta Platforms Technologies, LLC, Menlo Park, CA (US)

(21) Appl. No.: 18/616,923

(22) Filed: Mar. 26, 2024

Related U.S. Application Data
(60) Provisional application No. 63/539,654, filed on Sep. 21, 2023.

(51) Int. Cl. G06T 19/00; H04L 65/1069; H04L 65/65; H04L 65/70; H04L 65/80

(52) U.S. Cl. CPC G06T 19/00; H04L 65/1069; H04L 65/65; H04L 65/70; H04L 65/80; G06T 2219/024

(57) ABSTRACT

Systems and methods for managing avatar communications may include a wireless communication node which receives a data packet from a first wireless communication device. The data packet may include an identifier corresponding to a user of the first wireless communication device. The wireless communication node may generate an avatar for the user according to the identifier, receive an expression code from the first wireless communication device, and/or configure the avatar for the user according to the expression code. The wireless communication node may transmit video data corresponding to the avatar to an address of a second wireless communication device.

### CROSS-REFERENCE TO RELATED APPLICATIONS

This application claims the benefit of and priority to U.S. Provisional Application No. 63/539,654, filed Sep. 21, 2023, the contents of which are incorporated herein by reference in their entirety.

### FIELD OF DISCLOSURE

The present disclosure is generally related to wireless communication between devices, including but not limited to, systems and methods for managing avatar based communications.

### BACKGROUND

Augmented reality (AR), virtual reality (VR), and mixed reality (MR) are becoming more prevalent, which such technology being supported across a wider variety of platforms and device. Some AR/VR/MR devices may communicate with other devices within an environment via various cellular connections or links. As part of communication sessions and in various environments, some AR/VR/MR devices may render visual representations of avatars corresponding to end users.

### SUMMARY

In one aspect this disclosure relates to a method. The method includes receiving, by a communication node (e.g., ASN-A), a data packet from a first wireless communication device. The data packet may include an identifier (e.g., identity code) corresponding to a user of the first wireless communication device. The method further includes generating, by the communication node, an avatar for the user according to the identifier (e.g., by applying the identity code to the UPM). The method further includes receiving, by the communication node, an expression code from the first wireless communication device. The method further includes configuring, by the communication node, the avatar for the user according to the expression code. The method further includes transmitting, by the communication node, video data corresponding to the avatar to an address of a second wireless communication device (e.g., IP and port of receiving device, received from first device as part of session set up with ASN-A.).

In some embodiments, the method further includes receiving, by the communication node, a universal prior model for avatars. The communication node may generate the avatar for the user using the universal prior model. In some embodiments, the identifier includes an identity code corresponding to the user of the first wireless communication device. In some embodiments, the communication node applies the identity code to the universal prior model to generate the avatar for the user. In some embodiments, the data packet further includes configuration information (e.g., configuration information/personalization data for avatar) for augmenting the avatar. The configuration information may include at least one of a background, attire, or one or more avatar features. In some embodiments, the method further includes rendering, by the communication node, the avatar as three-dimensional video data. In some embodiments, the communication node and the first wireless communication device share a common network. In some embodiments, the communication node includes a node of an application server.

In some embodiments, receiving the expression code includes receiving, by the communication node, the expression code via a real-time transport protocol (RTP) message. The RTP message may include a timestamp. The timestamp may be used for synchronizing the video data with corresponding audio data generated by the first wireless communication device for rendering at the second wireless communication device. In some embodiments, the method further includes receiving, by the communication node, session information (e.g., session set-up information) from the first wireless communication device. The session information may include the address of the second wireless communication device.

In some aspects, this disclosure relates to a communication node. The communication node may include a transceiver (e.g., a transmitter and/or a receiver). The communication node may include one or more processors. The one or more processors may be configured to receive, via the transceiver, a data packet from a first wireless communication device. The data packet may include an identifier corresponding to a user of the first wireless communication device. The one or more processors may be configured to generate an avatar for the user according to the identifier. The one or more processors may be configured to receive an expression code from the first wireless communication device. The one or more processors may be configured to configure the avatar for the user according to the expression code. The one or more processors may be configured to transmit video data corresponding to the avatar to an address of a second wireless communication device.

In some embodiments, the one or more processors are further configured to receive a universal prior model for avatars. The one or more processors may generate the avatar for the user by applying the identifier to the universal prior model. In some embodiments, the identifier may include an identity code corresponding to the user of the first wireless communication device. In some embodiments, the data packet may further include configuration information for augmenting the avatar. The configuration information may include at least one of a background, attire, or one or more avatar features. In some embodiments, the one or more processors are further configured to render the avatar as three-dimensional video data.

In some embodiments, the one or more processors are configured to receive, via the transceiver, the expression code via a real-time transport protocol (RTP) message. The RTP message may include a timestamp. The timestamp may be used for synchronizing the video data with corresponding audio data generated by the first wireless communication device for rendering at the second wireless communication device. In some embodiments, the one or more processors are configured to receive, via the transceiver, session information from the first wireless communication device. The session information may include the address of the second wireless communication device.

In some aspects, this disclosure relates to a method. The method includes transmitting, by a first wireless communication device, a data packet to a communication node. The data packet may include an identifier corresponding to a user of the first wireless communication device. The communication node may generate an avatar for the user according to the identifier. The method further includes transmitting, by the first wireless communication device, an expression code to the communication node, and audio data to a second wireless communication device. The communication node may transmit video data corresponding to the avatar based on at least the expression code to the second wireless communication device, for rendering with the audio data.

In some embodiments, the data packet further includes configuration information for augmenting the avatar. The configuration information may include at least one of a background, attire, or one or more avatar features. In some embodiments, transmitting the expression code and transmitting the audio data includes transmitting, by the first wireless communication device, the expression code via a first real-time transport protocol (RTP) message to the communication node. In some embodiments, transmitting the expression code and transmitting the audio data includes transmitting, by the first wireless communication device, the audio data via a second RTP message to the second wireless communication device. In some embodiments, the first RTP message and the second RTP message include timestamps used for synchronizing rendering of the video data with the audio data.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of an architecture for avatar-based communication, according to an example implementation of the present disclosure.

FIG. 6 is a block diagram showing a signaling flow for avatar-based communication from a sender perspective, according to an example implementation of the present disclosure.

FIG. 7 is a block diagram showing a signaling flow for avatar-based communication from a receiver perspective, according to an example implementation of the present disclosure

FIG. 8 is a flow diagram for a method of avatar-based communication, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

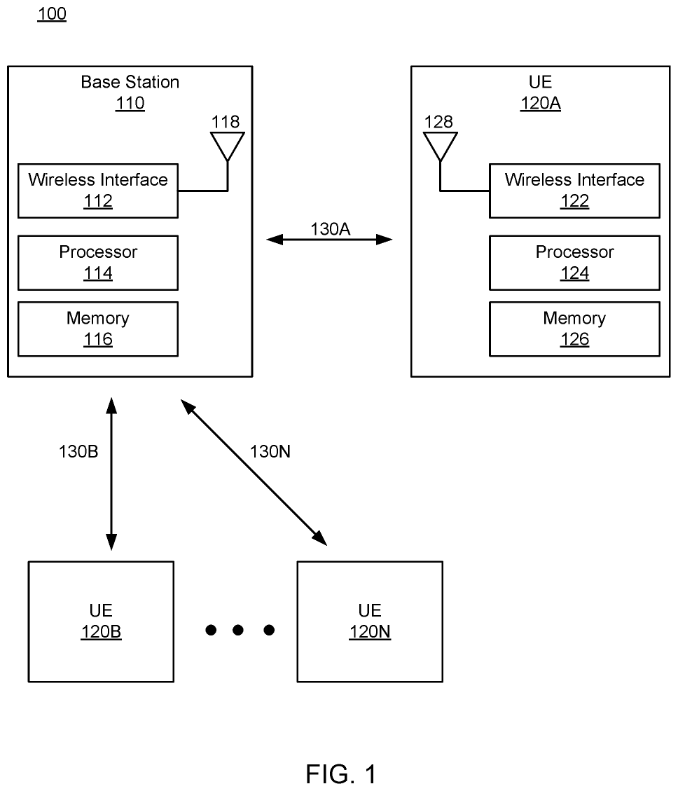

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless communication links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

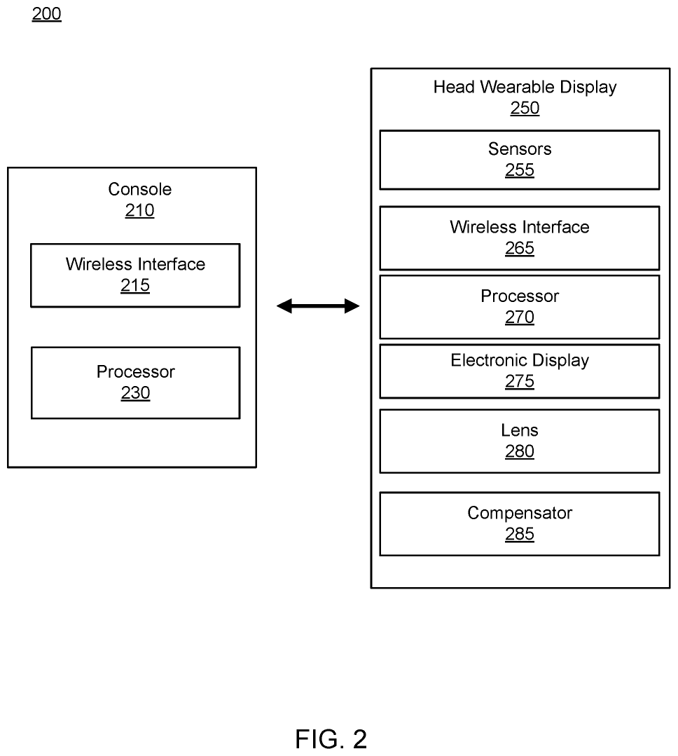

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

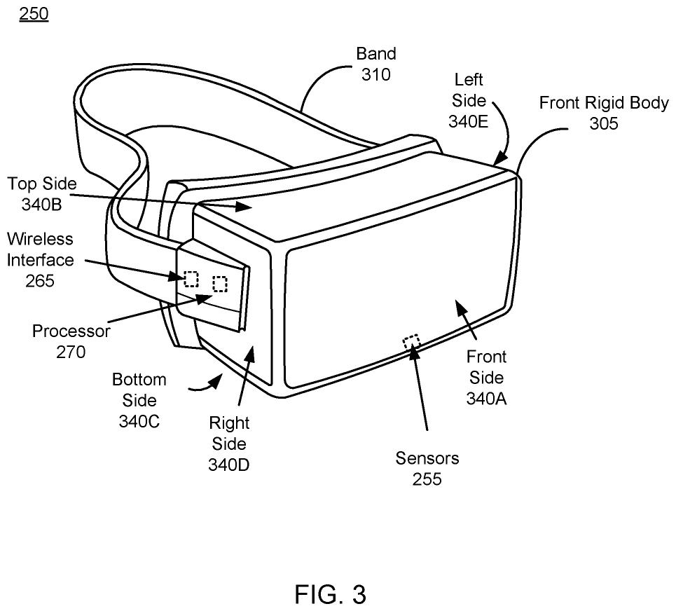

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 305, and may not be visible externally. In other embodiments, the HWD 250 has a different configuration than shown in FIG. 3. For example, the wireless interface 265, the processor 270, and/or the sensors 255 may be in different locations than shown in FIG. 3.

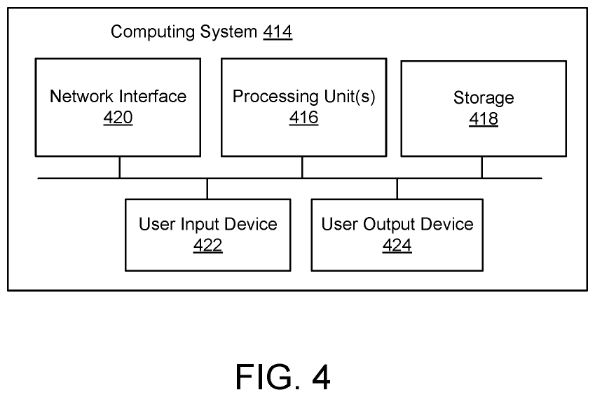

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

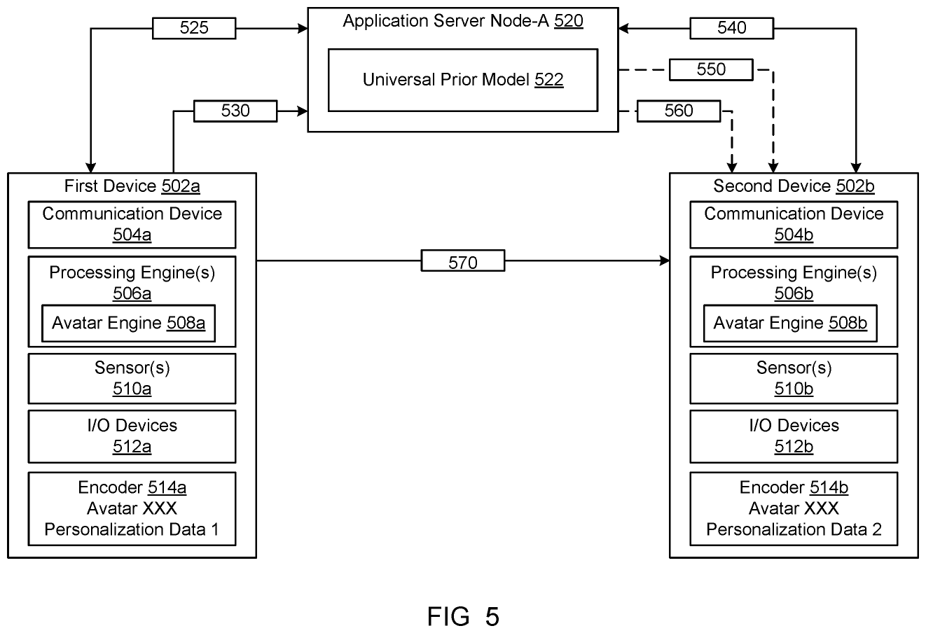

Referring generally to FIG. 5-FIG. 8, disclosed herein are related to systems and methods for managing avatar based communications. In real-time communication sessions between devices, such as video and audio calls or conferences, both the audio and video streams may be sent from a sender (or sending device) to a receiver (or receiving device). Such communication sessions may have different quality of service (QOS) flows for the different streams. For example, the video stream could be sent at a first data rate (e.g., ˜1 Mb/s) while the audio stream could be sent at a second data rate (e.g., ˜200 Kb/s). In an avatar-based communication session, a video representation of the sender may be rendered based on an identity and expression code of the sender. Rendering of the sender may be based on a method using a universal prior model (UPM). This can produce a realistic real-time video of the sender. Avatar communication can offer many types of augmented reality experiences from the sender to the receiver. For example, a sender can tailor different backgrounds, wear different outfits, etc. In addition, such communication may reduce the uplink (UL) transmission bandwidth requirements on the sender-side. However, if the receiver (or a third party) can retain the—“identity” and “expression” code of the sender, the re-creation of the sender's avatar may become much easier, which could lead to possible fraudulent usage. According to the systems and methods described herein, the present solution may provide an architecture in cellular communications in which avatar-based communications are based on the Universal Prior Model, but also provide privacy protections to the end users.

To prevent sensitive information like identity code and expression code of the user to be intercepted by or otherwise used by a third party or receiver (e.g., outside of the scope of the avatar communication session), the systems and methods described herein may provide an architecture where the Universal Prior Model (UPM) is managed in a network node that processes the input from sender (e.g., identity code/expression code) directly. The network node may then render those inputs into 3D video media to a party-B (e.g., using a real-time transfer protocol (RTP) or other signaling protocol). The audio stream can be sent directly from sender to receiver with RTP so those medias can be synchronized properly at the decoder side. Because avatar related information are kept at the A-party's network side, it is not exposed to third party or to receiver.

In various embodiments, an application server node-A (ASN-A) may store a UPM of a sender device corresponding to a user. The ASN-A may be managed by the avatar application provider that the sender device is using. Storing the UPM at the ASN-A may reduce a likelihood of fraudulent use of the avatar by the receiving party. The sender device may provide the identity code to the ASN-A via session signaling, which allows the ASN-A to create the corresponding user's avatar, without the ASN-A having to store the identity code of the user.

The sender device may send an expression code to the ASN-A using RTP, which incorporates the expression code into the corresponding avatar and generates the 3D video media for transmission to party-B, thereby allowing the party-B receiver to provide time synchronization (e.g., lip and sound synchronization) of audio with the 3D video media. Session signaling messages can also be used by the sender device to indicate to ASN-A the type of MR augmentation details with the avatar (e.g., background, avatar attire, etc.). The ASN-A may render the 3D media and can send the media to the server associated with the receiving device (e.g., via RTP). This allows both endpoints to perform time synchronization of audio and video. In at least some of the examples shown and described herein, the receiver device may perform split rendering between the receiver device and the server corresponding to the receiver device (e.g., where the server splits the 3D video into RGB and mesh data, which allows for efficient composition with the local content at the decoder side in the receiver device).

Referring to FIG. 5, a system 500 for avatar-based communication between a first device 502a and a second device 502b is shown, according to an example embodiment. The first device 502a and second device 502b may be generally referred to as “device 502” and, in some instances, may be referred to as “user equipment” or “UE”. The first device 502a and the second device 502b may be or may include one or more wireless devices including, but not limited to, smartphones, other mobile phones, tablet computers, wearable computing devices (e.g., smart watches, smart glasses, head wearable displays), desktop computers, laptop computers, or other computing devices. The first device 502a and the second device 502b may have a similar configuration of the UE 120A, 120B in FIG. 1, the computing system 414 in FIG. 4 and/or the HWDs 250 in FIG. 2. In some embodiments, the first device 502a and the second device 502b may each include one or more devices. For example, each of the first device 502a and the second device 502b may be or may include a HWD and/or a mobile cellular device communicably coupled to one another. The system 500 may include a communication node. The communication node may be a node of an application server (e.g., ASN-A 520). The communication node may include components similar to the base station 110, the computing system 414, and/or any other device, component, element, or hardware described above.

The first device 502a and the second device 502b may include one or more communication devices 504a, 504b. The communication devices 504a, 504b may be or may include one or more wired or wireless communication devices configured to form/establish a communication link between the first device 502a and the second device 502b. The communication devices 504a, 504b may include, but are not limited to, an antenna and/or radio (e.g., corresponding to communications sent via a Wi-Fi protocol, a wireless local area network (WLAN) protocol, a cellular protocol, an internet protocol, a ZigBee protocol, a Doppler protocol, or a Bluetooth™ protocol) and/or one or more wired lines (e.g., USB, Ethernet, Thunderbolt, co-axial, etc.). The communication devices 504a, 504b may have a similar configuration of the wireless interfaces 215 and/or network interface 420 in FIGS. 1-4.

The first device 502a and the second device 502b may include one or more processing engines 506a, 506b (e.g., similar to the processing unit 416 in FIG. 4). The processing engine(s) 506a, 506b may be or include any device, component, element, or hardware designed or configured to manage various portions of the respective first and second devices 502a, 502b as described herein. For example, the first device 502a and the second device 502b may include one or more avatar engines 508a, 508b. As described in greater detail herein, the avatar engines 508a, 508b may be configured to select an avatar and personalization data for the avatar to use for a communication session. The avatar engines 508a, 508b may be configured to apply the selected personalization data to an encoder and decoder pair corresponding to the selected avatar.

The first device 502a and the second device 502b may include one or more sensors 510a, 510b. For example, the sensors 510a, 510b may include one or more hardware components that can be configured to capture audio/video (A/V) data of a user of the respective first device 502a or second device 502b. The sensors 510a, 510b may be or may include, but are not limited to, one or more cameras, microphones, color sensors (e.g., red-green-blue (RGB)) sensors, depth sensor(s), and/or various other types of sensors that facilitate detecting movement of a user of the respective devices. The sensors 510a, 510b may include a depth field-of-view (FOV) and/or an image sensor FOV in both the latitudinal (or horizontal) direction and longitudinal (or vertical) direction. In some embodiments, the sensors 510a, 510b may be configured to capture directional data indicative of a gaze and/or facial expression of each respective user, and the devices 502a, 502b may be configured to transmit the directional data between one another.

The first device 502a and the second device 502b may include one or more I/O devices 512a, 512b. The I/O devices 512a, 512b may include any device (or devices) via which a user can provide signals to the processing engines 506a, 506b to interpret the signals as indicative of particular user requests or information. I/O devices 512a, 512b may include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on. The I/O devices 512a, 512b may include any device via which first device 502a or the second device 502b can provide information to a user. For example, the I/O devices 512a, 512b can include a display image generated by or delivered to the devices. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. The I/O devices 512a, 512b may be provided in addition to or instead of a display. Examples include indicator lights, speakers, tactile “display” devices, printers, and so on.

The first device 502a and the second device 502b may include one or more encoders 514a, 514b. The encoders 514a, 514b may include or be implemented in hardware, or at least a combination of hardware and software. For example, the encoders 514a, 514b may include a device, circuit, software, or a combination of a device, circuit, and/or software to convert data (e.g., direction, image, audio, and/or video data) from one format (e.g., sensor data) to a second or different format (e.g., an encoded identity code and/or expression code). For example, the encoders 514a, 514b may include avatar encoders that may be configured to process and encode image/video/directional data as a corresponding code, as described herein.

The encoders 514 may be configured to generate, configure, or otherwise define an identity code for a user of the respective user of the device 502. For example, using the sensor(s) 510, the encoder 514 may be configured to determine, detect, or otherwise identify facial traits, characteristics, and so forth of the user. Such characteristics may be indicative of or representative of modifications of the universal prior model (UPM) 522 relative to the user's observed/detected/identified characteristics. For example, the identity code may include modified weights applied to standard/set/defined weights of the UPM 522, such that, when the identity code is applied to the UPM 522, the UPM 522 is configured to generate an avatar which has an appearance which is similar to the user. In some embodiments, the encoders 514 may be configured to generate or configure the identity code for the user at application set-up (e.g., responsive to enrolling with an application hosted or provided by ASN-A 520). For example, as part of application set-up, the user may be prompted to capture facial images and depth data of the user via the first device 502 at various viewing angles. The encoder 514 may be configured to generate the identity code for the user, based on or according to the captured facial images and depth data.

The encoders 514 may be configured to generate, configure, or otherwise define expression codes for the user of the respective user of the device 502. The expression codes may be or include encoded information indicating the user's current expression. The encoders 514 may be configured to generate the expression codes in real-time (or near-real time) during an avatar communication session. For example, the encoders 514 may be configured to process sensor data indicative of the user's expression (e.g., smiling, frowning, gazing away, etc.), to generate expression codes which indicate or otherwise identify the user's expression.

As shown in FIG. 5, a communication node 520 may serve the first UE 502a (e.g., the sender). The communication node may be or include a wireless or wired communication node. In various embodiments, the communication node may be or include a node of an application server which hosts, provisions, or otherwise provides an application which facilitates the avatar communication session (e.g., application server node A (ASN-A) 520). The ASN-A 520, as stated above, may store, include, maintain, or otherwise access a UPM 522. As described above, the ASN-A 520 may be configured to use the UPM 522 and an identity code of a user, to generate an avatar specific to the user. By generating the avatar at ASN-A 520, using the identity code of the sender, the systems and methods described herein may prevent fraud or reuse of an identity code of a sender, by the receiver (e.g., second UE 502b). In various embodiments, the sending party/network (e.g., first UE 502a) may control the ASN-A 520 to secure the node. This may prevent data or UPM 522 information from being exposed outside of the sender network.

To begin an avatar communication session (e.g., following or as part of session negotiation and set-up between the first UE 502a and second UE 502b), the first UE 502a may send the identity code to the ASN-A 520 for applying to the UPM 522, as shown by communication link 525. The identity code may be sent via session signaling. In various embodiments, the identity code is locally stored at the first UE 502a (e.g., the ASN-A 520 does not store the identity code). Locally storing the identity code may protect the identity code from misuse or fraud. Receipt of the identity code by the UPM 522 may allow the ASN-A 520 to generate the avatar of the first UE 502a (e.g., by ASN-A 520 applying the identity code to the UPM 522 to configure a model for generating the avatar specific to the user). In various embodiments, the identity code is sent to the ASN-A 520 during session set up/negotiation with the second UE 502b.

In various embodiments, the first UE 502a may also send a session signaling message to the ASN-A 520 to indicate configuration data. Configuration data may include mixed-reality (MR) augmentation details associated with the avatar of the user of the first UE 502a. The configuration data may include information corresponding to, for example, a background to be rendered, clothing to be worn, etc. In various embodiments, the user of the first device 502a may be configured to select (e.g., via the application) the configuration/augmentation details prior to session set-up and negotiation, and/or during the communication session. The session signaling message is shown in FIG. 5 by the communication link 525. In some embodiments, the first UE 502a may send the session signal at the same time as the identity code (e.g., as part of the same data packet). In various embodiments, a session signal may be sent multiple times during an avatar communication session. For example, an updated or new session signal may be sent any time the user updates or modifies augmentation details (e.g., changes a background, etc.).

During the session, the first device 502a may be configured to communicate, send, or otherwise provide expression code(s) to the ASN-A 520 for configuring the avatar according to the user's expression. The first device 502a may be configured to generate audio data (captured of the user of the first device 502a, and send the audio data (e.g., via communication link 570) to the second device 502b. As described in greater detail below, the ASN-A 520 may be configured to generate and render (e.g., as RGB-D data and/or 3D video data) the avatar based on the expression code. The ASN-A 520 may be configured to communicate, send, or otherwise provide the rendered avatar to the second device 502b (e.g., via one or more of the communication links 540-560). The second device 502b, upon receiving the audio data and the rendered avatar, may be configured to render/display/provide the rendered avatar to the user of the second device 502b, synchronized with the audio data.

As described above, the encoder 514 may be configured to generate expression code(s) based on the sensed/detected/identified expressions of the user during the session. The first UE 502a may send the expression code to the ASN-A 520, as shown by communication link 530. In various instances, as the user's expression changes during the session, the first UE 502a may send a plurality of expression codes to the UPM 522, where each code corresponding to an updated expression. As stated above, an expression code may be related to updated facial expressions by the user of the first UE 502a. For example, the identity code sent to the UPM 522 may indicate the facial features or overall appearance to be rendered as the avatar. The expression code may be associated with expressions or movements of the user to be rendered, in real time or substantially real time, on the avatar. For example, an updated expression code may be sent to the UPM 522 each time the user being rendered as an avatar changes their facial expression (e.g., smiles, frowns, turns their head, etc.). The first UE 502a may detect (e.g., based on data of the sensors 510a) a change in the expression of a user. The encoder 514a may be configured to generate the updated expression code based on the change in expression.

In some embodiments, the first UE 502a may be configured to transmit, send, or otherwise signal the expression code to the ASN-A 520 via a real time protocol (RTP) signal (or other signaling protocol). For example, the first UE 502a (e.g., the encoder 514a and/or the communication device 504a) may be configured to generate an RTP signal or packet which includes the expression code. The first UE 502a (e.g., the communication device 504a) may be configured to transmit the RTP signal (e.g., via the cellular connection illustrated by communication link 530a) to ASN-A 520. The ASN-A 520, upon receipt of the expression code from the first UE 502a, may be configured to update the configuration of the avatar based on or according to the expression code. For example, the ASN-A 520 may be configured to generate and render video data (e.g., RGB-D, 3D video, etc.) of the avatar having an expression which corresponds to the expression code.

In some embodiments, the first UE 502a may be configured to communicate, send, transmit, or otherwise provide the audio stream data to the second UE 502b, as shown by communication link 570. In some embodiments, the first UE502a may be configured to generate the audio stream data with corresponding timestamps, and the expression codes with similar and/or related timestamps. Such implementations may provide for synchronization of the audio and resultant video stream data, based on the timestamps. For example, and in various embodiments, the first UE 502a sending the expression code (e.g., with timestamps) to the ASN-A 520 via RTP may allow the ASN-A 520 to generate an appropriate timestamp of the media, which may allow time-synchronization of the video and audio at the receiving party (e.g., the second UE 502b).

In some embodiments, such synchronization may be performed by the second UE 502b and/or at a party-B side network node. For example, and in various embodiments, the receiver (e.g., second UE 502b) may utilize split rendering and synchronization. In as split rendering embodiment, the second UE 502b may be configured to receive the 3D video data (e.g., mesh and RGB data and/or RGB-D data) from ASN-A 520 (e.g., via communication link 550). In some embodiments, the second UE 502b may receive the 3D video data from ASN-A 520 via the communication link 550 by a receiver-side network device (e.g., a base station and/or an ASN-B (similar to ASN-A)). The second UE 502b may be configured to receive the audio data (e.g., as an audio stream) from the first UE 502a (e.g., via a cellular network connection 570). In some embodiments, as part of split rendering, the second UE 502b may be configured to receive the audio data via the ASN-A and/or ASN-B (or other receiver-side network device) via communication link 560. The second UE 502b may be configured to render the 3D video data synchronized with the audio data using the timestamps of the respective streams/content.

In various embodiments, a party-B side network node may be configured to perform synchronization. For example, a receiver-side network node (such as a base station or ASN-B) may be configured to receive the audio stream from the first UE 502a, and the 3D video data from ASN-A 520. The receiver-side network node may be configured to synchronize the video data and audio data using the timestamps of the respective streams/content, and render the content as audio/video (A/V) content. The receiver-side network node may be configured to transmit, send, or otherwise provide the A/V content (via RTP) to the second UE 502b via communication link 540, for rendering/displaying/providing to the second user.

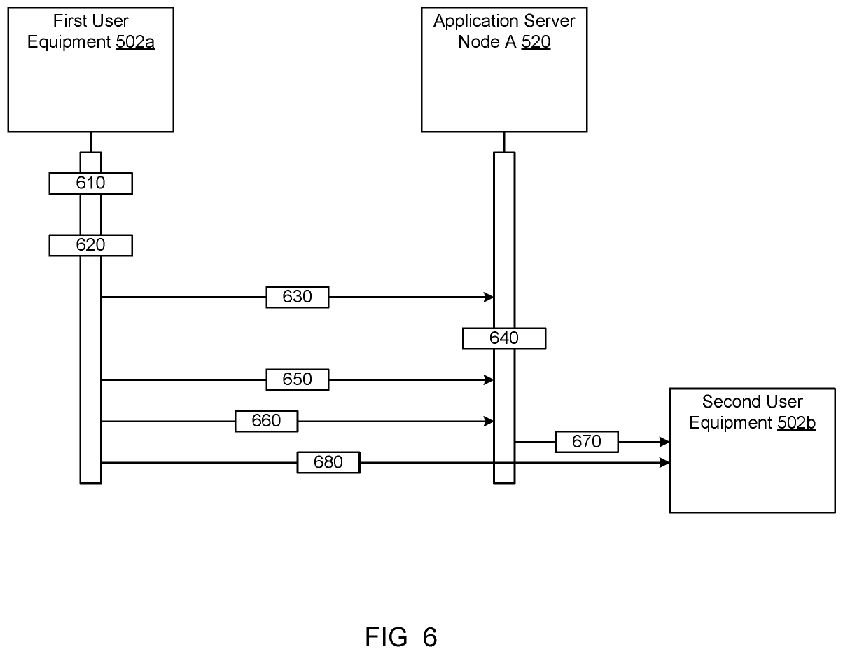

Referring now to FIG. 6, a signaling flow is shown, for avatar-based communication from a sender perspective, according to an example embodiment. In various embodiments, the avatar-based communication may occur in a cellular network. More specifically, the signaling flow described with respect to FIG. 6 illustrates avatar communication in a 5G communication system. In various embodiments, the system may include additional components not shown in the figures, such as a user plane function (UPF) and/or a next generation radio access network (NG-RAN).

At step 610, a protocol data unit (PDU) session may be established. The PDU session may generate, establish, or otherwise configure a user plane connection via a cellular network, which facilitates the sending device (e.g., the first UE 502a) to send data/information via the cellular network to another device (e.g., the second UE 502b). The PDU session may be established as part of an avatar communication session. In some embodiments, the first UE 502a may negotiate the PDU session with the second UE 502b as part of establishing the avatar communication session. The first UE 502a and second UE 502b may negotiate the session responsive to a user launching an application corresponding to the avatar communication session (e.g., the application hosted or supported by ASN-A 520)

At step 620, the first UE 502a may utilize application level signaling to establish an RTP session with the second UE 502b. The RTP session may facilitate a data exchange between the first and second UEs 502a,b. For example, as part of session negotiation and setup (e.g., at steps 610 and 620), the first UE 502a may receive media endpoint information (e.g., internet protocol (IP) address and port number) and media codec information from the second UE 502b. By providing such information, the first UE 502a can address and send audio and/or video data for receipt by the second UE 502b. In various embodiments, steps 610 and 620 may not be specific to avatar communication (e.g., steps 610 and 620 may be applicable to non-avatar communication in a cellular network communication system). After steps 610 and 620, the sender can begin to establish avatar communication with the ASN-A 520.

At step 630, the first UE 502a may establish avatar setup signaling (e.g., a signaling for setting up an avatar) with the ASN-A 520. Prior to establishing the avatar setup signaling, the ASN-A 520 and/or UPM 522 may contain an artificial intelligence (AI) command model. Thus, the ASN-A 520 and/or UPM 522 may be capable of rendering an avatar, once an identity code has been received from the first UE 502a, to generate an avatar specific to the sender. At step 630, as part of avatar setup signaling, the first UE 502a may be configured to transmit, send, or otherwise provide identity code and configuration information corresponding to the user of the first UE 502a to ASN-A 520. The identity code may be or include the identity code described above and generated by the encoder 514a. The configuration information may be or include specific configuration/context/rendering settings for the avatar. The encoder 514a may be configured to receive such settings from the user as part of session setup (and/or based on default settings), and generate the configuration information for transmission to ASN-A 520.

At step 640, the ASN-A 520 can generate an avatar for the first user. To generate the avatar, the ASN-A 520 may utilize the UPM 522 and the identity code. For example, the ASN-A 520 may be configured to apply the identity code to the UPM 522, to generate the avatar configured for the user of the first UE 502a. As stated above, the identity code may include or correspond to one or more modifications to the UPM 522. Thus, by applying the identity code to the UPM 522, the ASN-A 520 may generate the avatar for the user by applying the modifications (e.g., to weights, features, etc.) to the UPM 522. In various embodiments, the configuration data may augment the generation of the avatar. As such, the ASN-A 520 may be configured to generate the avatar by applying the configuration data to the generated/rendered avatar.

At step 650, the first UE 502a establishes an RTP session with the ASN-A 520. The RTP session may indicate video session codec/endpoint information of the second UE 502b. The first UE 502a may transmit, send, or otherwise provide the endpoint information of the second UE 502b (e.g., determined/identified at step 610 and step 620). The RTP session may facilitate the first UE 502a to send the expression code to the ASN-A 520, as indicated by communication link 660. For example, the first UE 502a (e.g., the encoder 514a) may be configured to generate expression codes corresponding to sensed expressions of the user during the avatar communication session. The first UE 502a may be configured to send the expression codes via communication link 660 to the ASN-A 520. Responsive to the ASN-A 520 receiving the expression code(s) from the first UE 502a, ASN-A 520 may be configured to update the avatar to have an expression which corresponds to the expression code. In various embodiments, the expression code may be associated with a timestamp, to allow the video data and audio data to be synchronized at the second UE 502b. Responsive to receiving the expression code, ASN-A 520 may be configured to generate and/or render video content (e.g., 2D/3D video data) for transmission to the endpoint (e.g., the second UE 502b) as indicated in the session setup information provided at step 650. In other words, at step 670, the ASN-A 520 may stream, communicate, transmit, or otherwise provide video content (e.g., 2D or 3D video) to the second UE 502b via RTP, as indicated by communication link. At step 680, the first UE 502a may send an audio stream to the second UE 502b via RTP (e.g., without first providing the audio data to ASN-A 520). In the embodiment shown in FIG. 6, both the video and audio RTP streams may be synchronized locally at the second UE 502b (e.g., by the avatar engine 508b). While shown as local synchronization, in various embodiments, an intermediary device, such as an ASN-B or wireless communication node, may be configured to perform synchronization and transmit the synchronized audio and video data to the second UE 502b for rendering.

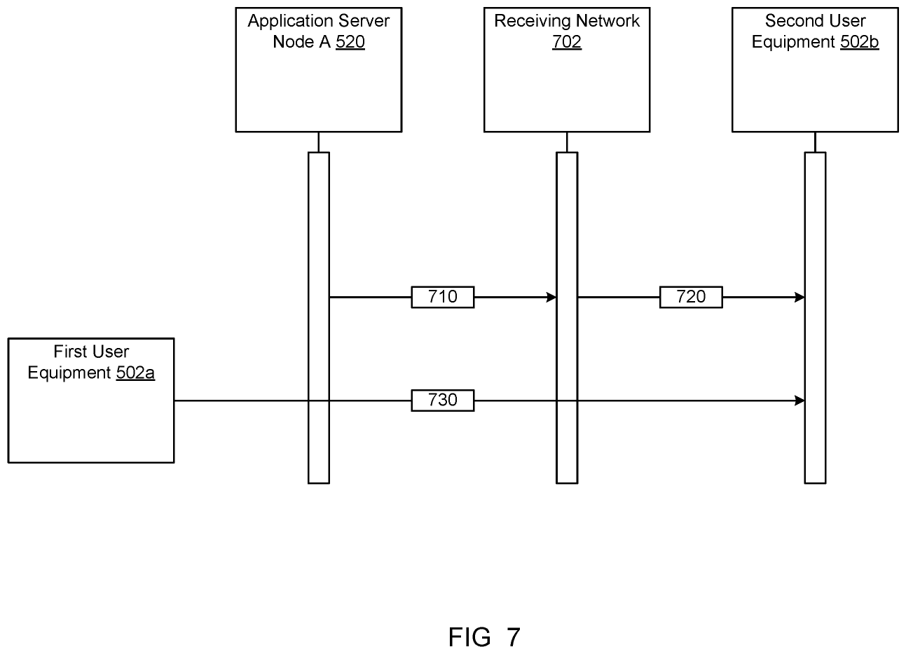

Referring now to FIG. 7, a signaling flow for avatar-based communication of FIG. 6 is shown from a receiver perspective, according to an example embodiment. In various embodiments, the receiver side may include, in addition to the second UE 502b, a receiving network 702. The receiving network 702 may be or include an application server node (e.g., ASN-B), a wireless communication or cellular node (e.g., a base station), etc. The receiving network 702 may receive audio and/or video data from the ASN-A 520 and/or the first UE 502a, and may transmit the received data to the second UE 502b, as described in greater detail below.

At step 710, the ASN-A 520 may transmit, e.g., via RTP, video data (e.g., 2D video and/or 3D video corresponding to an avatar of the first user) to the receiving network 702. As such, step 710 may correspond to step 670 of FIG. 6. At step 720, the receiving network 702 may transmit the video data to the second UE 502b. In some embodiments, the receiving network 702 may determine the destination for the data. For example, the ASN-A 520 may include, incorporate, or otherwise provide the IP address and port number for the receiving device (e.g., the second UE 502b) in the video data sent by the ASN-A 520 and received by the receiving network 702. The receiving network 702 may be configured to determine the IP address and port number from the video data, and transmit, send, or otherwise provide the video data to the endpoint corresponding to the IP address and port number (e.g., the second UE 502b). At step 730, audio data may be sent, via RTP, to the receiving device or endpoint (e.g., second UE 502b). The second UE 502b may perform time synchronization, to synchronize the audio and video data that have been sent from different locations (e.g., ASN-A 520 and the first UE 502a). In various embodiments, the first UE 502a may be configured to send the audio data to the receiving network 702. In such embodiments, the receiving network 702 may be configured to perform time synchronization, and provide the synchronized content to the second UE 502b (e.g., as A/V content).

While the preceding methods of FIG. 6 and FIG. 7 are described within the context of the first UE 502a as the sending device and the second UE 502b as the receiving device, it is noted that, in various instances, the second UE 502b may also function as a sending device (e.g., for an avatar corresponding to the user of the second UE 502b) and the first UE 502a may also function as a receiving device. In other words, similar steps may be performed by both devices, as part of an avatar communication session between the devices 502a,b. Additionally, while shown as two devices, any number of sending and receiving devices may form an avatar communication session.

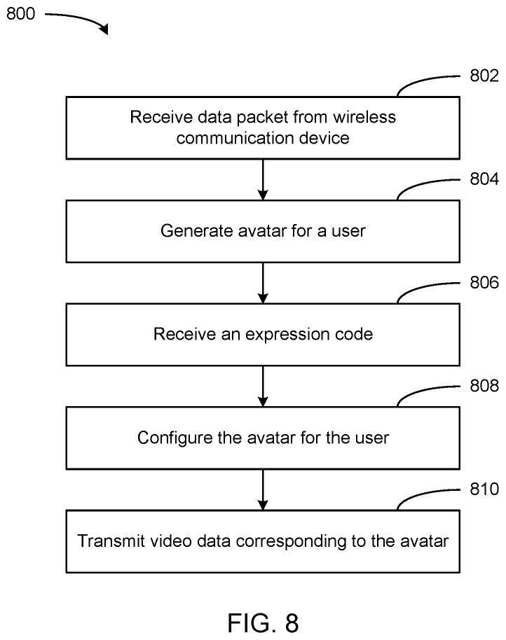

Referring to FIG. 8, a method 800 of avatar communication between a first wireless communication device and a second wireless communication device is shown, according to an example embodiment. The method 800 may be performed by devices, components, elements, and hardware described above with reference to FIG. 1 through FIG. 7. In various embodiments, the method 800 may be performed by ASN-A 520 described above.

At step 802, a communication node receives a data packet from the first wireless communication device. The communication node may receive the data packet responsive to a PDU session being established between the communication node, the first wireless communication device, and the second wireless communication device. In various embodiments, at step 802, the communication node may also receive, maintain, identify, or otherwise access a universal prior model for avatars. In various embodiments, the data packet may include an identifier corresponding to a user of the first wireless communication device. The identifier may include an identity code corresponding to a user of the first wireless communication device. In various embodiments, the data packet further includes configuration information for augmenting the avatar. The configuration information may include at least one of a background, attire, or one or more avatar features.

In various embodiments, the communication node may include a node of an application server (e.g., application server node 520). In various embodiments, the communication node and the first wireless communication device may share a common network. In various embodiments, at step 802, the communication node may also receive session information from the first wireless communication device. The session information may include, for example, an address of the second wireless communication device.

At step 804, the communication node generates the avatar for the user according to the identifier. The avatar may be generated responsive to receiving the data packet and/or the universal prior model for avatars at step 802. In various embodiments, the communication node may generate the avatar for the user using the universal prior model. In various embodiments, the communication node may apply the identity code to the universal prior model to generate the avatar for the user.

At step 806, the communication node receives an expression code from the first wireless communication device. The expression code may be received responsive to an indication that the user has updated their expression. In various embodiments, at step 806, the communication node may receive the expression code via a real-time transport protocol (RTP) message. The RTP message may include a timestamp. The timestamp may be used for synchronizing video data with corresponding audio data. The audio data may be generated by the first wireless communication device for rendering at the second wireless communication device.

At step 808, the communication node configures the avatar for the user according to the expression code. The avatar may be configured responsive to the communication node receiving an expression code. In various embodiments, the communication node may receive updated expression codes in real-time or substantially real-time as the user changes their expression (e.g., as detected by the first wireless communication device). At step 810, the communication node transmits video data corresponding to the avatar to an address of a second wireless communication device. The video data may be transmitted responsive to the avatar being properly configured in step 808. In various embodiments, at step 810 the communication node may render the avatar as three-dimensional video data, for transmission to the second wireless communication device.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an example embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other example embodiments, and that such variations are intended to be encompassed by the present disclosure.

What is claimed is:

1. A method comprising:
receiving, by a communication node, a data packet from a first wireless communication device, the data packet including an identifier corresponding to a user of the first wireless communication device;
generating, by the communication node, an avatar for the user according to the identifier;
receiving, by the communication node, an expression code from the first wireless communication device;
configuring, by the communication node, the avatar for the user according to the expression code; and
transmitting, by the communication node, video data corresponding to the avatar to an address of a second wireless communication device.

2. The method of claim 1, further comprising:
receiving, by the communication node, a universal prior model for avatars,
wherein the wireless communication node generates the avatar for the user using the universal prior model.

3. The method of claim 2, wherein the identifier comprises an identity code corresponding to the user of the first wireless communication device, the communication node applying the identity code to the universal prior model to generate the avatar for the user.

4. The method of claim 1, wherein the data packet further comprises configuration information for augmenting the avatar, the configuration information including at least one of a background, attire, or one or more avatar features.

5. The method of claim 1, further comprising rendering, by the communication node, the avatar as three-dimensional video data.

6. The method of claim 1, wherein the communication node and the first wireless communication device share a common network.

7. The method of claim 6, wherein the communication node comprises a node of an application server.

8. The method of claim 1, wherein receiving the expression code comprises receiving, by the communication node, the expression code via a real-time transport protocol (RTP) message, the RTP message including a timestamp, the timestamp used for synchronizing the video data with corresponding audio data generated by the first wireless communication device for rendering at the second wireless communication device.

9. The method of claim 1, further comprising receiving, by the communication node, session information from the first wireless communication device, the session information including the address of the second wireless communication device.

10. A communication node, comprising:
a transceiver; and
one or more processors configured to:
receive, via the transceiver, a data packet from a first wireless communication device, the data packet including an identifier corresponding to a user of the first wireless communication device;
generate an avatar for the user according to the identifier;
receive an expression code from the first wireless communication device;
configure the avatar for the user according to the expression code; and
transmit video data corresponding to the avatar to an address of a second wireless communication device.

11. The communication node of claim 10, wherein the one or more processors are configured to:
receive a universal prior model for avatars,
wherein the one or more processors generate the avatar for the user by applying the identifier to the universal prior model.

12. The communication node of claim 11, wherein the identifier comprises an identity code corresponding to the user of the first wireless communication device.

13. The communication node of claim 10, wherein the data packet further comprises configuration information for augmenting the avatar, the configuration information including at least one of a background, attire, or one or more avatar features.

14. The communication node of claim 10, wherein the one or more processors are further configured to render the avatar as three-dimensional video data.

15. The communication node of claim 10, wherein the one or more processors are configured to receive, via the transceiver, the expression code via a real-time transport protocol (RTP) message, the RTP message including a timestamp, the timestamp used for synchronizing the video data with corresponding audio data generated by the first wireless communication device for rendering at the second wireless communication device.

16. The communication node of claim 10, wherein the one or more processors are configured to receive, via the transceiver, session information from the first wireless communication device, the session information including the address of the second wireless communication device.

17. A method, comprising:
transmitting, by a first wireless communication device, a data packet to a communication node, the data packet including an identifier corresponding to a user of the first wireless communication device, the communication node generating an avatar for the user according to the identifier; and
transmitting, by the first wireless communication device, an expression code to the communication node, and audio data to a second wireless communication device, the communication node transmitting video data corresponding to the avatar based at least on the expression code to the second wireless communication device, for rendering with the audio data.

18. The method of claim 17, wherein the data packet further comprises configuration information for augmenting the avatar, the configuration information including at least one of a background, attire, or one or more avatar features.

19. The method of claim 17, wherein transmitting the expression code and transmitting the audio data comprises:
transmitting, by the first wireless communication device, the expression code via a first real-time transport protocol (RTP) message to the communication node; and
transmitting, by the first wireless communication device, the audio data via a second RTP message to the second wireless communication device.

20. The method of claim 19, wherein the first RTP message and the second RTP message include timestamps used for synchronizing rendering of the video data with the audio data.
